(19) United States
(12) Patent Application Publication
(10) Pub. No.: US 2017/0076129 A1
(43) Pub. Date: Mar. 16, 2017

(54) CAPACITIVE SENSING DEVICE AND SIGNAL PROCESSING METHOD THEREOF

(71) Applicant: EGIS TECHNOLOGY INC., Taipei City (TW)

(72) Inventor: TODD LIN, TAIPEI CITY (TW)

(21) Appl. No.: 14/959,224

(22) Filed: Dec. 4, 2015

(30) Foreign Application Priority Data
Sep. 15, 2015 (CN) 201510585368.3

(51) Int. Cl. G06K 9/00

(52) U.S. Cl. CPC G06K 9/0002

(57) ABSTRACT

The present invention illustrates a capacitive sensor device and signal processing method thereof. The capacitive sensing device comprises a sensing array, a reading module and a signal separator. The sensing array comprises a plurality of sensing units. Each of the sensing units will generate a sensing voltage when a user's finger presses on the sensing array. The reading module reads the sensing voltages and generates a sensing output corresponding to each of the sensing voltages. The signal separator processes each of the sensing outputs to generate a sensing signal and a biomedical signal.

### BACKGROUND OF THE INVENTION

1. Field of the Invention

The present invention relates to a capacitive sensing device and a signal processing method thereof; in particular, to a capacitive sensing device and signal processing method thereof where a sensing signal and a living body micro current are separated so as to simultaneously detect a touch event or perform fingerprint identification and to monitor a user's biological status.

2. Description of Related Art

Recently, personal health management has become a trend and the need for long-term biological monitoring and health care has also increased. Thus, how to make a biological monitoring system that can be easily used in our daily life is worth discussing.

The industry of wearable biological monitoring devices are growing, improving inconvenience in using the enormous monitoring devices which are applied in hospitals. However, the volume and weight of the nowadays wearable biological monitoring devices are still large so as to make the user feel uncomfortable during examination, causing the user's mental stress and reluctance to be examined or monitored.

On the other hand, when a user presses his/her finger on a sensing surface of a conventional capacitive touch sensing device, the sensing units in the sensing device will generate capacitance values correspondingly. The capacitive touch sensing device uses the capacitance values to generate sensing voltages for touch event detection.

Also, when the user presses his/her finger on the sensing surface of a conventional fingerprint identification device, the sensing units of the fingerprint identification device will generate capacitance values corresponding to the peaks and valleys of the user's fingerprint. Thus, the fingerprint identification device can obtain a fingerprint pattern corresponding to the surface of the user's finger for fingerprint identification.

The sensing output by the conventional capacitive touch sensing device or fingerprint identification device comprises not only sensing signals which can be used for touch event detection or fingerprint identification but also living body micro current. However, the living body micro current would be considered as noise and thus be removed.

### SUMMARY OF THE INVENTION

The present invention provides a capacitive sensing device. The capacitive sensing device comprises a sensing array, a reading module and a signal separator. The sensing array comprises a plurality of sensing units. Each of the sensing units will generate a sensing voltage when a user's finger presses on the sensing array. The reading module reads the sensing voltages and generates a sensing output corresponding to each of the sensing voltages. The signal separator processes each of the sensing outputs to generate a sensing signal and a biomedical signal.

In one embodiment of the present invention, the biomedical signals generated by the signal separator are sourced from a living body micro current associated with the user's finger.

In one embodiment of the present invention, the capacitive sensing device further comprises a processor. The processor determines a touch event associated with the user's finger according to the sensing signals and generates biological information associated with the user according to the biomedical signals.

In one embodiment of the present invention, the capacitive sensing device further comprises a processor. The processor obtains a fingerprint pattern related to the finger according to the sensing signal. When the fingerprint identification of the fingerprint pattern is verified, the processor will generate biological information associated with the user according to the biomedical signals.

The present invention further provides a signal processing method used in a capacitive sensing device. The capacitive sensing device comprises a sensing array comprising a plurality of sensing units. The signal processing method comprises: generating a sensing voltage when a user's finger presses on the sensing array via each of the sensing units; reading the sensing voltages, and further generating a sensing output corresponding to each of the sensing voltages; and processing each of the sensing outputs via a signal separator to generate a sensing signal and a biomedical signal.

In one embodiment of the present invention, the biomedical signals generated by the signal separator are sourced from a living body micro current associated with the user's finger.

In one embodiment of the present invention, the signal processing method further comprises the step that: determining a touch event via a processor according to the sensing signal and generating biological information associated with the user according to the biomedical signal.

In one embodiment of the present invention, the signal processing method further comprises the step that: obtaining a fingerprint pattern associated with the user's finger according to the sensing signals via a processor. When the fingerprint identification of the fingerprint pattern is verified, the processor will generate biological information associated with the user according to the biomedical signals.

For further understanding of the present invention, reference is made to the following detailed description illustrating the embodiments and embodiments of the present invention. The description is only for illustrating the present invention, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a block diagram of a capacitive sensing device of one embodiment of the present invention.

FIG. 2 shows a flow chart of a signal processing method of one embodiment of the present invention.

FIG. 3A shows a schematic drawing of a capacitive fingerprint identification device of one embodiment of the present invention.

FIG. 3B shows a block diagram of a capacitive fingerprint identification device of one embodiment of the present invention.

FIG. 4 shows a flow chart of a signal processing method of another embodiment of the present invention.

### DETAILED DESCRIPTION OF PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings. In addition, for easy illustration, the same reference numbers or symbols refer to like elements. To be brief, the capacitive sensing device according to the present invention can be a capacitive touch panel or a capacitive fingerprint identification device, but it is not limited herein. In the following description, the capacitive touch panel is taken for example, but it would not restrict the present invention.

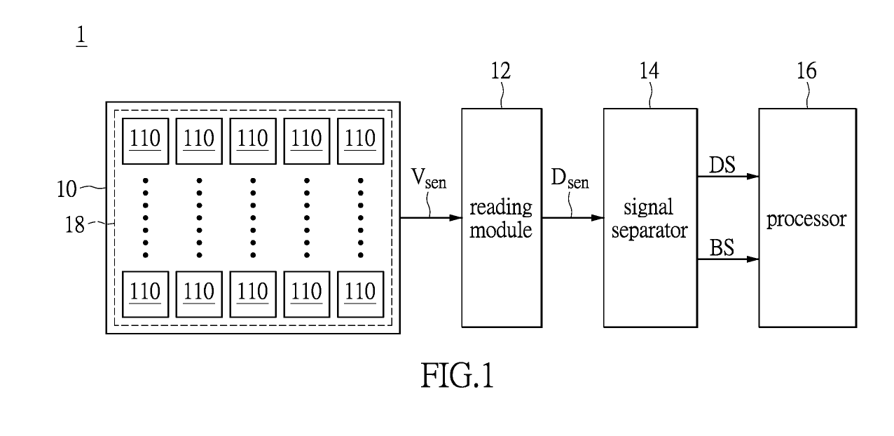

Please refer to FIG. 1. FIG. 1 shows a block diagram of a capacitive sensing device of one embodiment of the present invention. The capacitive sensing device 1 is a touch panel, and comprises a sensing array 10, a reading module 12, a signal separator 14 and a processor 16. The sensing array 10, the reading module 12, the signal separator 14 and the processor 16 can be integrally or separately configured on the semiconductor substrate of the capacitive sensing device 1, but it is not limited herein. Additionally, the sensing array 10 comprises a plurality of sensing units 110 arranged in a 2-dimensional array, and there is an insulating surface 18 covering all sensing units 110 of the sensing array 10.

When a user presses his/her finger (not shown) on the insulating surface 18, each of the sensing units 110 in the sensing array 10 will generate a sensing voltage Vₛₑₙ. A sensing output Dₛₑₙ corresponding to each of the sensing voltages Vₛₑₙ will then be generated. After that, the signal separator 14 processes the sensing output Dₛₑₙ so as to generate a sensing signal DS and a biomedical signal BS. Finally, the processor 16 determines whether there is a touch event and where the touch event happens according to the sensing signal DS, and generates biological information related to the user according to the biomedical signal BS.

The sensing voltage Vₛₑₙ is generated according to the capacitance value between the finger and the sensing unit 110. However, the capacitance value may be affected by a living body micro current from the user's finger, so there would be an error in the sensing output. To solve this problem, traditionally, the living body micro current from the user's finger is considered as a noise, and it is removed in order to obtain a more accurate sensing signal.

However, the living body micro current comprises valuable biological information relating to the user. As the technologies of integrated circuit, micro-fabrication, artificial neural network advance, the living body micro current can be well processed so as to be applied in the field of biological monitoring technology. Thus, the capacitive sensing device 1 according to the embodiment of the present invention is provided for generating the user's biomedical signal BS according to the living body micro current so as to perform biological monitoring.

Moreover, in the present invention, biological information can be any kind of biological information included in the living body micro current, such as an Electrocardiogram (ECG) information, an Electromyogram (EMG) information, an Electrogastroenterogram (EGEG) information, an Electrogastrogram (EGG) information and the like.

The processor 16 can further comprise an artificial neural network model (not shown) for executing a smart computation on the biomedical signal BS so as to generate biological information related to the user. It is worth mentioning that the technology of the artificial neural network model is well-known to those skilled in the art, and thus, for simplicity, the technology is not described here.

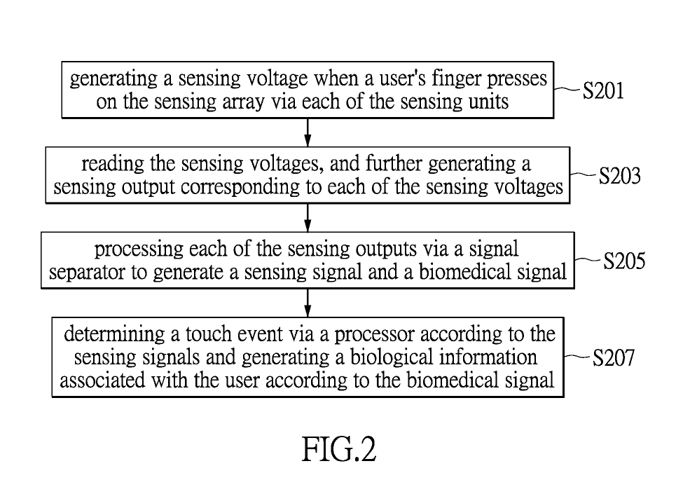

In addition, for illustrating an operation flow of the capacitive sensing device 1 of the present invention, the present invention further provides one embodiment of a signal processing method. FIG. 2 shows a flow chart of a signal processing method of one embodiment of the present invention. Moreover, the explanatory steps of the present embodiment may be embodied with the capacitive sensing device 1 in FIG. 1, and thus FIG. 1 is referred to for easy illustration and better understanding.

In step S201, when the user's finger touches on a sensing surface of the capacitive sensing device, a plurality of sensing voltages corresponding to the sensing units in the sensing array of the capacitive sensing device are generated. In step S203, the sensing voltages are read and a plurality of sensing outputs corresponding to the sensing voltages are provided. After that, in step S205, the sensing outputs are processed by a signal separator so as to generate a sensing signal and a biomedical signal. Finally, in step S207, a touch event is detected according to the sensing signal, and biological information related to the user is generated according to the biomedical signal.

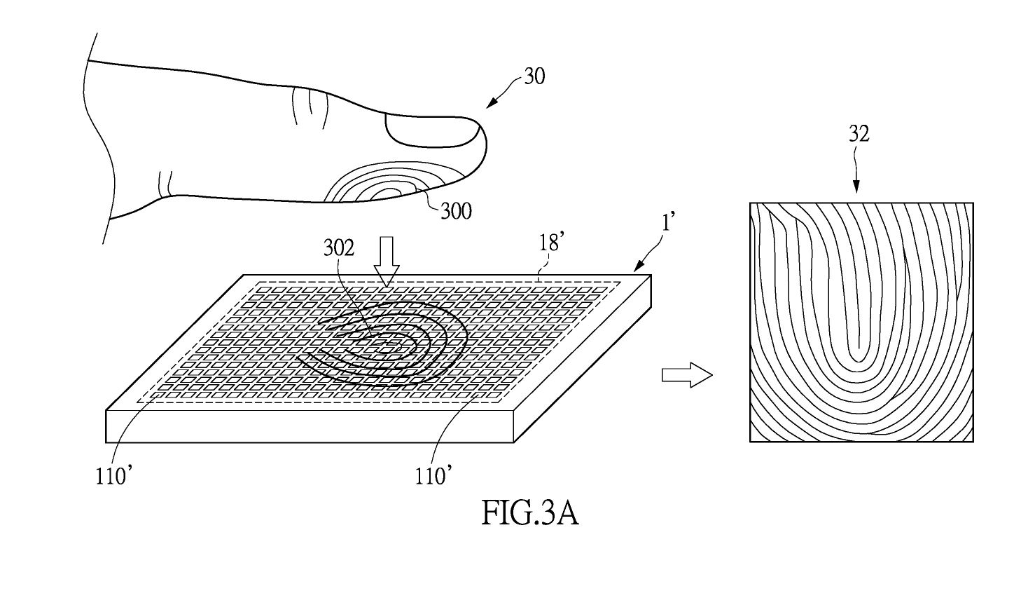

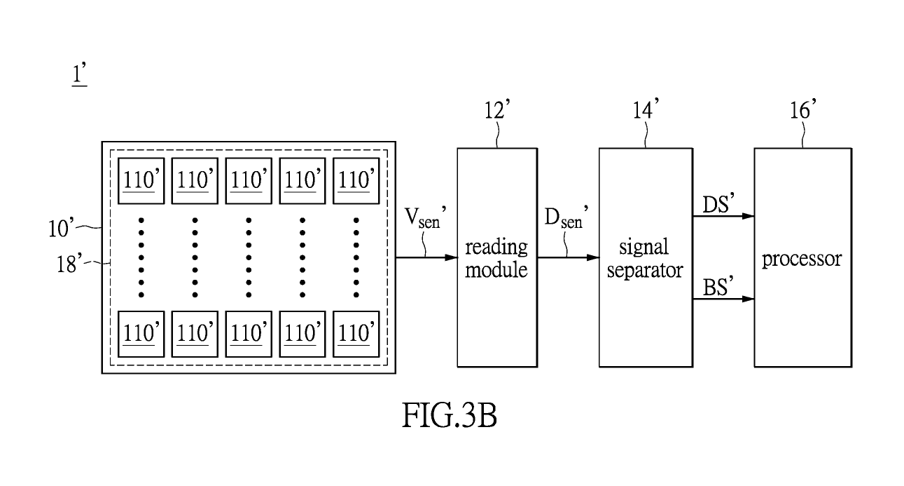

In addition, the capacitive sensing device according to the embodiment of the present invention can be a capacitive fingerprint identification device. Please refer to FIG. 3A, which shows a schematic drawing of a capacitive fingerprint identification device of one embodiment of the present invention.

Briefly speaking, when the user presses his/her finger on the sensing surface of the capacitive fingerprint identification device 1′, the capacitive fingerprint identification device 1′ will obtain a capacitance curve 302 corresponding to the peaks 300 of the user's fingerprint and identify the shape of the peaks 300 of the fingerprint according to the shape of the capacitance curve 302, so as to obtain a fingerprint pattern 32 corresponding to the finger 30. Thereby, the capacitive fingerprint identification device 1′ can perform the fingerprint identification according to the fingerprint pattern 32.

Also refer to FIG. 3B, which shows a block diagram of a capacitive fingerprint identification device of one embodiment of the present invention. Briefly, the capacitive fingerprint identification device 1′ comprises a sensing array 10′, a reading module 12′, a signal separator 14′ and a processor 16′. The sensing array 10′ comprises a plurality of sensing units 110′ arranged as a 2-dimensional array, and an insulating surface 18′ which covers all sensing units 110′ in the sensing array 10′.

When the user's finger 30 presses on the insulating surface 18′, the capacitive fingerprint identification device 1′ will obtain a sensing voltage Vₛₑₙ′ of each sensing unit 110′ in the sensing array 10′. The reading module 12′ provides a corresponding sensing output Dₛₑₙ′ according to the sensing voltage Vₛₑₙ′. After that, the signal separator 14′ processes each of the sensing outputs Dₛₑₙ′ to generate a sensing signal DS' and a biomedical signal BS′. Finally, the processor 16′ obtains a fingerprint pattern 32 corresponding to the finger 30 according to the sensing signals DS′, and generates biological information associated with the user according to the biomedical signals BS′.

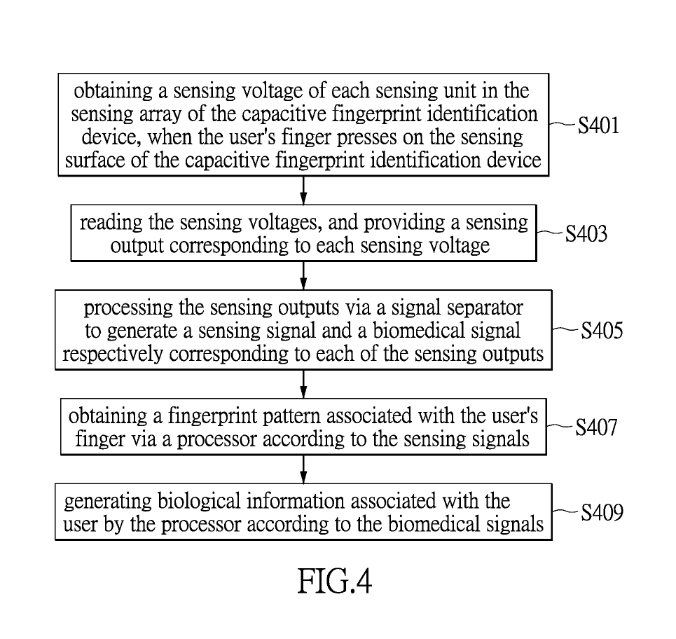

Please refer to FIG. 4, which shows a flow chart of a signal processing method of another embodiment of the present invention.

In step S401, when the user's finger presses on the sensing surface of the capacitive fingerprint identification device, a sensing voltage of each sensing unit in the sensing array of the capacitive fingerprint identification device is obtained. In step S403, the sensing voltages are read, and a sensing output corresponding to each sensing voltage is provided. After that, in step S405, the sensing outputs are processed via a signal separator to generate a sensing signal and a biomedical signal respectively corresponding to each of the sensing outputs. In step S407, a fingerprint pattern associated with the user's finger is obtained via a processor according to the sensing signals. Finally, in step S409, biological information associated with the user is generated by the processor according to the biomedical signals.

It is worth mentioning that in the above method, it can also be designed to perform step S409 only when the fingerprint identification of the obtained fingerprint pattern in step S407 is verified. In other words, if the user is not a verified user, the capacitive fingerprint identification device 1′ in the embodiment according to the present invention will not generate any biological information associated with the user according to the biomedical signals BS′. It is also worth mentioning that the technology of the fingerprint identification is well-known to those skilled in the art, and thus the detailed description about the fingerprint identification is not presented here.

The descriptions illustrated supra set forth simply the preferred embodiments of the present invention; however, the characteristics of the present invention are by no means restricted thereto. All changes, alterations, or modifications conveniently considered by those skilled in the art are deemed to be encompassed within the scope of the present invention delineated by the following claims.

What is claimed is:

1. A capacitive sensing device, comprising:
a sensing array, comprising a plurality of sensing units, wherein each of the sensing units will generate a sensing voltage when a user's finger presses on the sensing array;
a reading module, reading the sensing voltages and generating a sensing output corresponding to each of the sensing voltages; and
a signal separator, processing each of the sensing outputs to generate a sensing signal and a biomedical signal.

2. The capacitive sensing device according to claim 1, further comprising:
a processor, determining a touch event according to the sensing signals and generating biological information associated with the user according to the biomedical signals.

3. The capacitive sensing device according to claim 2, wherein the biological information is an Electrocardiogram (ECG) information, an Electromyogram (EMG) information, an Electrogastroenterogram (EGEG) information or an Electrogastrogram (EGG) information.

4. The capacitive sensing device according to claim 1, wherein the biomedical signals generated by the signal separator are sourced from a living body micro current associated with the user's finger.

5. The capacitive sensing device according to claim 2, wherein the processor comprises:
an artificial neural network model, executing a smart computation on the biomedical signals to generate biological information associated with the user.

6. The capacitive sensing device according to claim 1, further comprising:
a processor, obtaining a fingerprint pattern associated with the user's finger according to the sensing signals.

7. The capacitive sensing device according to claim 6, wherein the processor generates biological information associated with the user according to the biomedical signals.

8. The capacitive sensing device according to claim 6, wherein after the fingerprint pattern is verified, the processor generates biological information associated with the user according to the biomedical signals.

9. A signal processing method, used in a capacitive sensing device, wherein the capacitive sensing device comprises a sensing array comprising a plurality of sensing units, the signal processing method comprising:
generating a sensing voltage when a user's finger presses on the sensing array via each of the sensing units;
reading the sensing voltages, and further generating a sensing output corresponding to each of the sensing voltages; and
processing each of the sensing outputs via a signal separator to generate a sensing signal and a biomedical signal.

10. The signal processing method according to claim 9, further comprising:
determining a touch event via a processor according to the sensing signals and generating biological information associated with the user according to the biomedical signal.

11. The signal processing method according to claim 10, wherein the biological information is an Electrocardiogram (ECG) information, an Electromyogram (EMG) information, an Electrogastroenterogram (EGEG) information or an Electrogastrogram (EGG) information.

12. The signal processing method according to claim 9, wherein the biomedical signals generated by the signal separator are sourced from a living body micro current associated with the user's finger.

13. The signal processing method according to claim 9, further comprising:
executing a smart computation on the biomedical signals to generate biological information associated with the user via an artificial neural network model.

14. The signal processing method according to claim 9, further comprising:
obtaining a fingerprint pattern associated with the user's finger according to the sensing signals via a processor.

15. The signal processing method according to claim 14, wherein the processor generates biological information associated with the user according to the biomedical signals.

16. The signal processing method according to claim 14, wherein when the fingerprint pattern is verified, the processor will generate biological information associated with the user according to the biomedical signals.
